(19) United States
(12) Patent Application Publication
(10) Pub. No.: US 2026/0066995 A1
(43) Pub. Date: Mar. 5, 2026

(54) OPTICAL TRANSMITTER

(71) Applicant: Fujitsu Limited, Kawasaki-shi (JP)

(72) Inventor: Tomoyuki AKIYAMA, Yokohama (JP)

(73) Assignee: Fujitsu Limited, Kawasaki-shi (JP)

(21) Appl. No.: 19/318,720

(22) Filed: Sep. 4, 2025

(30) Foreign Application Priority Data
Sep. 5, 2024 (JP) 2024-152859

(51) Int. Cl. H04B 10/572; H04J 14/02

(52) U.S. Cl. CPC H04B 10/572; H04J 14/02

(57) ABSTRACT

A plurality of modulated optical signals are generated using a reference light source and a plurality of tunable light sources. An optical circuit that combines the plurality of modulated optical signals includes a plurality of sub-optical circuits that configure a binary tree circuit. A reference optical signal generated using the reference light source is guided to an output port of one or more of the plurality of sub-optical circuits. The transmission characteristic of each sub-optical circuit and the oscillation frequency of each tunable light source are controlled based on a monitor value representing the optical power of the output port of each sub-optical circuit and a monitor value representing the optical power of the input port of the sub-optical circuit to which the reference optical signal is input.

### CROSS-REFERENCE TO RELATED APPLICATION

This application is based upon and claims the benefit of priority of Japanese Patent Application No. 2024-152859 filed on Sep. 5, 2024, the entire contents of which are incorporated herein by reference.

### FIELD

A certain aspect of the present embodiments relates to an optical transmitter and an optical transceiver.

### BACKGROUND

Optical communication systems that transmit multiple optical signals in parallel by multiplexing multiple different subcarriers (or wavelengths) have been put to practical use. In such optical communication systems, the baud rate of each subcarrier can be lowered, so the power consumption of the optical transmitter (or optical transceiver) can be reduced. Note that the technology for multiplexing multiple different wavelengths to transmit multiple optical signals is described in, for example, Japanese Patent Application Publication No. 2021-152569 and Japanese Patent Application Publication No. 2022-077082.

### SUMMARY

According to an aspect of the present disclosure, there is provided an optical transmitter that multiplexes and outputs a plurality of optical signals, including: a plurality of light sources; a plurality of optical modulators that generate a plurality of modulated optical signals using output light of the plurality of light sources; and an optical circuit that multiplexes the plurality of modulated optical signals, wherein: one of the plurality of light sources is a reference light source that outputs a reference light; other light sources of the plurality of light sources are wavelength-tunable light sources; the optical circuit includes a plurality of sub-optical circuits; each of the plurality of sub-optical circuits has a first port, a second port, a third port, and a fourth port; each of the plurality of sub-optical circuits has a periodic transmission characteristic; transmission characteristic between the first port and the third port and transmission characteristic between the second port and the fourth port are substantially same; transmission characteristic between the first port and the fourth port and transmission characteristic between the second port and the third port are substantially same; transmission characteristic between the first port and the third port and transmission characteristic between the first port and the fourth port are complementary; transmission characteristic between the second port and the third port and transmission characteristic between the second port and the fourth port are complementary; each of the plurality of sub-optical circuits includes a phase shifter for adjusting transmission characteristic; each of the plurality of sub-optical circuits is configured to multiplex an input light of the first port and an input light of the second port by the phase shifter and output a multiplexed light through the third port; the plurality of sub-optical circuits are optically coupled to each other to configure a binary tree circuit including N stages; the third port of a set of sub-optical circuits provided in an (i+1)-th stage of the binary tree circuit is optically coupled to the first port and the second port of a sub-optical circuit provided in an i-th stage of the binary tree circuit with respect to an output port of the optical transmitter; corresponding modulated optical signals among the plurality of modulated optical signals are guided from the plurality of optical modulators to the first port and the second port of each sub-optical circuit provided in an N-th stage of the binary tree circuit; and a reference optical signal generated by one of the plurality of optical modulators using the reference light is guided to the fourth port of an output stage sub-optical circuit connected to the output port of the optical transmitter.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram of an example of an optical transmitter for transmitting a WDM signal;

FIG. 2A and FIG. 2B are diagrams of an example of power consumption and cost of an optical transceiver with respect to a number of subcarriers;

FIG. 3 is a diagram of an example of an optical transmitter according to an embodiment of the present invention;

FIG. 4 is a diagram of an example of an arrangement of light output from multiple light sources;

FIG. 5A and FIG. 5B are a diagrams of an example of a configuration of a sub-optical circuit;

FIG. 6 is a diagram explaining transmission characteristics of a sub-optical circuit;

FIG. 7A to FIG. 7D are diagrams of an example of filter characteristics of a sub-optical circuit;

FIG. 8 is a diagram of a schematic diagram of a binary tree circuit formed from multiple sub-optical circuits;

FIG. 9 is a diagram of an example of a configuration of a sub-optical circuit (part 1);

FIG. 10 is a diagram of an example of a operation of a sub-optical circuit illustrated in FIG. 9;

FIG. 11 is a diagram of an example of a configuration of a sub-optical circuit (part 2);

FIG. 12 is a diagram of an example of an operation of a sub-optical circuit illustrated in FIG. 11;

FIG. 13 is a diagram of an example of a configuration of a sub-optical circuit (part 3);

FIG. 14 is a diagram of an example of an operation of a sub-optical circuit for shaping a spectrum;

FIG. 15 is a diagram of an example of an operation of a sub-optical circuit provided at an output stage of an optical circuit;

FIG. 16 is a diagram of an example of an operation of a sub-optical circuit for a reference optical signal (part 1);

FIG. 17 is a diagram of an example of an operation of a sub-optical circuit for a reference optical signal (part 2);

FIG. 18 is a diagram of an example of an operation of a sub-optical circuit for a reference optical signal (part 3);

FIG. 19 is a diagram of an example of effect of cost reduction according to an embodiment of the present invention;

FIG. 20 is a flowchart of an example of a control method used in an optical transmitter;

FIG. 21 is a diagram of results of a simulation of a process of correcting a frequency of each subcarrier;

FIG. 22A and FIG. 22B are diagrams of results of a simulation of a transmittance of an optical transmitter; and

FIG. 23 is a diagram of an example of an optical transceiver according to an embodiment of the present invention.

### DETAILED DESCRIPTION

An optical transmitter (or optical transceiver) for multiplexing multiple different subcarriers (or wavelengths) to transmit multiple optical signals is equipped with multiple light sources. Here, to achieve high-quality optical communications, it is desirable that each light source generates light of a specified frequency with high precision. However, light sources that can generate light of a specified frequency with high precision are expensive. Therefore, to achieve high-quality optical communications, the cost of the optical transmitter (or optical transceiver) becomes high.

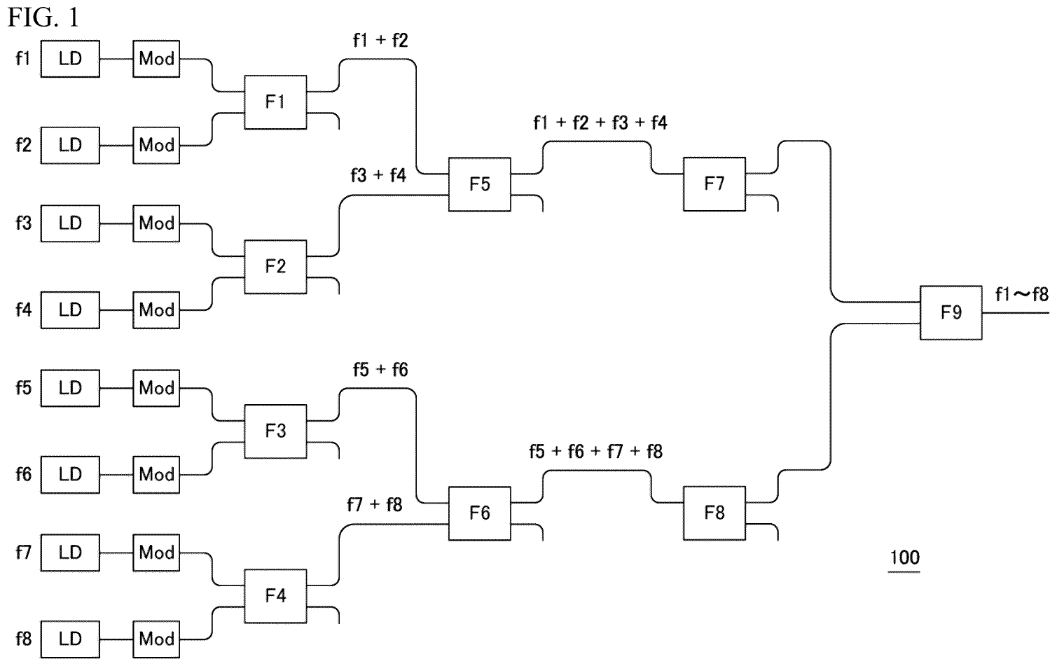

FIG. 1 illustrates an example of an optical transmitter that transmits a WDM signal. An optical transmitter 100 illustrated in FIG. 1 includes a plurality of light sources LD and a plurality of optical modulators Mod, and generates a plurality of modulated optical signals.

The plurality of light sources LD output light of different frequencies (or wavelengths). Each of the optical modulators Mod generates a modulated optical signal by modulating the continuous light output from the corresponding light source LD with a data signal. In this example, the optical transmitter 100 includes eight light sources LD and eight optical modulators Mod, and generates eight modulated optical signals. The eight light sources LD output light of frequencies f1 to f8 (or wavelengths λ1 to λ8). In the following description, the modulated optical signal of frequency fi (i=1 to 8) may be referred to as the “optical signal fi”.

The optical transmitter 100 includes an optical circuit that combines the plurality of modulated optical signals. This optical circuit includes sub-optical circuits F1 to F9.

The sub-optical circuit F1 multiplexes optical signals f1 and f2. In the following description, the optical signal obtained by multiplexing optical signals fi and fj may be referred to as “optical signal fi+fj.” The sub-optical circuit F2 multiplexes optical signals f3 and f4 to generate optical signal f3+f4, the sub-optical circuit F3 multiplexes optical signals f5 and f6 to generate optical signal f5+f6, and the sub-optical circuit F4 multiplexes optical signals f7 and f8 to generate optical signal f7+f8. The sub-optical circuit F5 combines optical signals f1+f2 and f3+f4 to generate optical signal f1+f2+f3+f4, and the sub-optical circuit F6 combines optical signals f5+f6 and f7+f8 to generate optical signal f5+f6+f7+f8.

The sub-optical circuit F7 shapes the spectra of the optical signals (f1, f2, f3, f4) that make up the optical signal f1+f2+f3+f4, and the sub-optical circuit F8 shapes the spectra of the optical signals (f5, f6, f7, f8) that make up the optical signal f5+f6+f7+f8. Then, the sub-optical circuit F9 multiplexes the optical signals f1+f2+f3+f4 and f5+f6+f7+f8 to generate the optical signal f1+f2+f3+f4+f5+f6+f7+f8.

In the optical transmitter 100 configured as above, it is preferable that the optical signals f1 to f8 are set on a predetermined frequency grid. That is, it is preferable that the optical signals f1 to f8 are arranged at a predetermined frequency interval. Here, if the optical signals f1 to f8 are set on a predetermined frequency grid with high precision, the quality of the optical signals f1 to f8 may be high. Therefore, it is preferable that each light source LD is a light source that can generate light of a specified frequency with high precision (hereinafter, a high-precision light source).

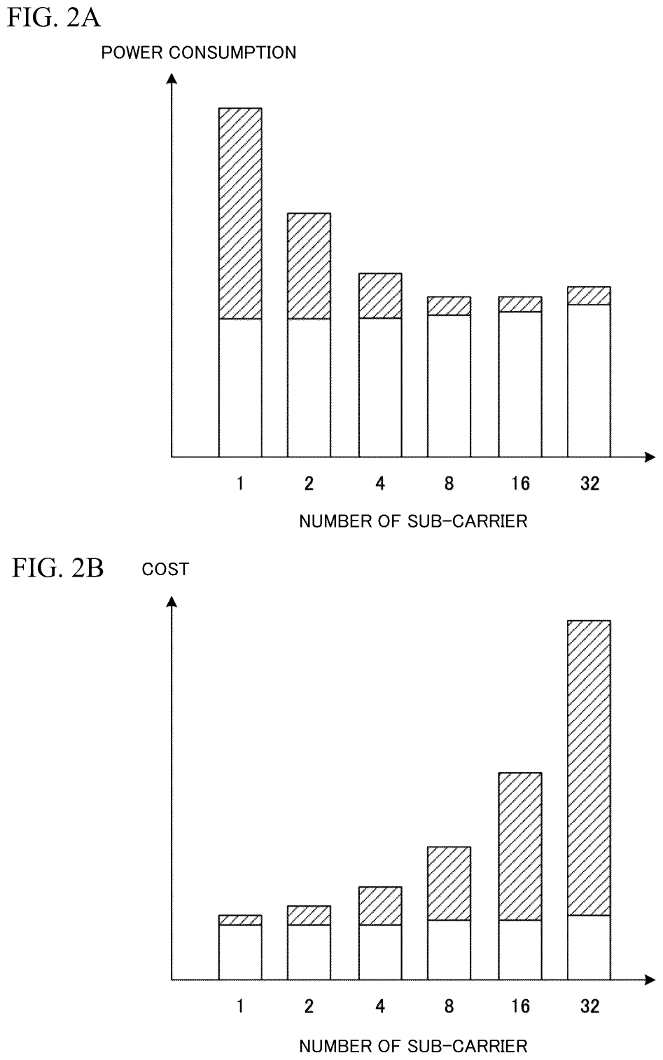

However, high-precision light sources are expensive. Therefore, in a configuration in which a large number of optical signals are multiplexed into a WDM signal, the cost of the optical transmitter may increase. For example, by increasing the number of subcarriers (or the number of wavelength channels) and lowering the baud rate per subcarrier, the power consumption of the optical transmitter can be reduced as illustrated in FIG. 2A. In FIG. 2A, the shaded area represents the power consumption of the light source (and the optical modulator). However, an optical transmitter that transmits a WDM signal needs to have the same number of light sources as the number of subcarriers. Therefore, when the number of subcarriers is increased, the cost of the optical transmitter increases as illustrated in FIG. 2B. In FIG. 2B, the shaded area represents the cost of the light source. The cost of the light source is proportional to the number of light sources provided in the optical transmitting device.

### Embodiment

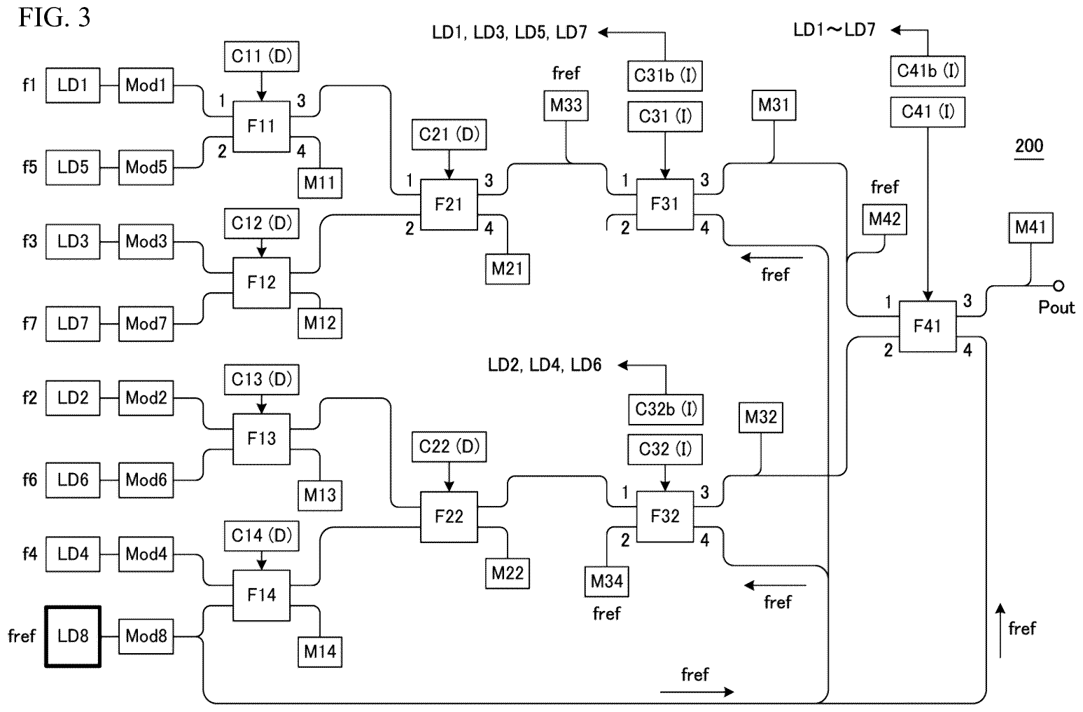

FIG. 3 illustrates an example of an optical transmitter according to an embodiment of the present invention. An optical transmitter 200 according to an embodiment of the present invention can generate a WDM signal in which eight subcarriers (f1 to f7, fref) are combined or multiplexed. In other words, the optical transmitter 200 can generate a WDM signal in which eight modulated optical signals are multiplexed.

The optical transmitter 200 includes tunable light sources LD1 to LD7, a high-precision light source LD8, optical modulators Mod1 to Mod8, and sub-optical circuits F11 to F14, F21 to F22, F31 to F32, and F41. In addition, the optical transmitter 200 includes optical monitors M11-M14, M21-M22, M31-M34, and M41-M42, and controllers C11-14, C21-C22, C31-C32, and C41.

The high-precision light source LD8 is configured to output continuous light of a pre-specified reference frequency fref. The reference frequency fref is, for example, one of a number of frequencies defined as a frequency grid for WDM transmission. The high-precision light source LD8 may include, for example, an optical bandpass filter that transmits the reference frequency fref. The high-precision light source LD8 may also be configured to be frequency (or wavelength) adjustable.

The tunable light sources LD1-LD7 each output continuous light. The frequency of the continuous light output by each tunable light source LD1-LD7 is controlled by a controller. In this embodiment, the frequencies of the tunable light sources LD1 to LD7 are controlled to f1 to f7, respectively. In this embodiment, the frequencies f1 to f7 are controlled so as to be arranged on a frequency grid for WDM transmission. Unlike the high-precision light source LD8, each of the tunable light sources LD1 to LD7 does not have an optical bandpass filter that transmits a predetermined frequency. Therefore, each of the tunable light sources LD1 to LD7 is less expensive than the high-precision light source LD8.

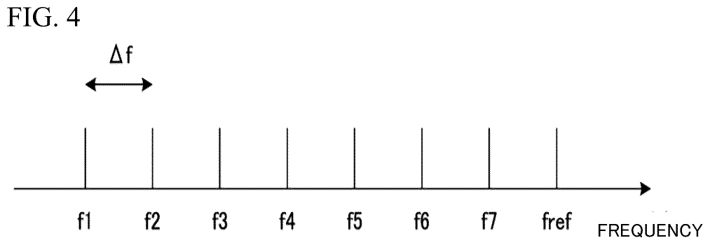

FIG. 4 illustrates an example of the arrangement of the oscillation frequencies of the tunable light sources LD1 to LD7 and the high-precision light source LD8. In this embodiment, the continuous light generated by the tunable light sources LD1 to LD7 and the continuous light generated by the high-precision light source LD8 are arranged at a constant frequency interval Δf. Δf corresponds to the frequency interval defined as the frequency grid for WDM transmission.

Each of the optical modulator Mod1 to Mod8 modulates the continuous light output from the corresponding light source to generate a modulated optical signal. Specifically, the optical modulators Mod1 to Mod7 modulate the continuous light output from the wavelength-tunable light sources LD1 to LD7, respectively, to generate modulated optical signals. The optical modulator Mod8 modulates the continuous light output from the high-precision light source LD8 to generate a modulated optical signal. In the following description, the modulated optical signal generated by the optical modulator Modi using the continuous light output from the wavelength-tunable light source LDi (i=1 to 7) may be referred to as the “optical signal fi”. In addition, the modulated optical signal generated by the optical modulator Mod8 using the continuous light output from the optical modulator Mod8 may be referred to as the “reference optical signal fref”. The reference optical signal fref is referred to in order to adjust the optical transmitter 200, but can transmit data in the same manner as the other optical signals f1 to f7.

Each of the sub-optical circuits F11-F14, F21-F22, F31-F32, and F41 is an optical device having two input ports (P1, P2) and two output ports (P3, P4). In the following, each of the sub-optical circuits F11-F14, F21-F22, F31-F32, and F41 may be collectively referred to as the “sub-optical circuit F.”

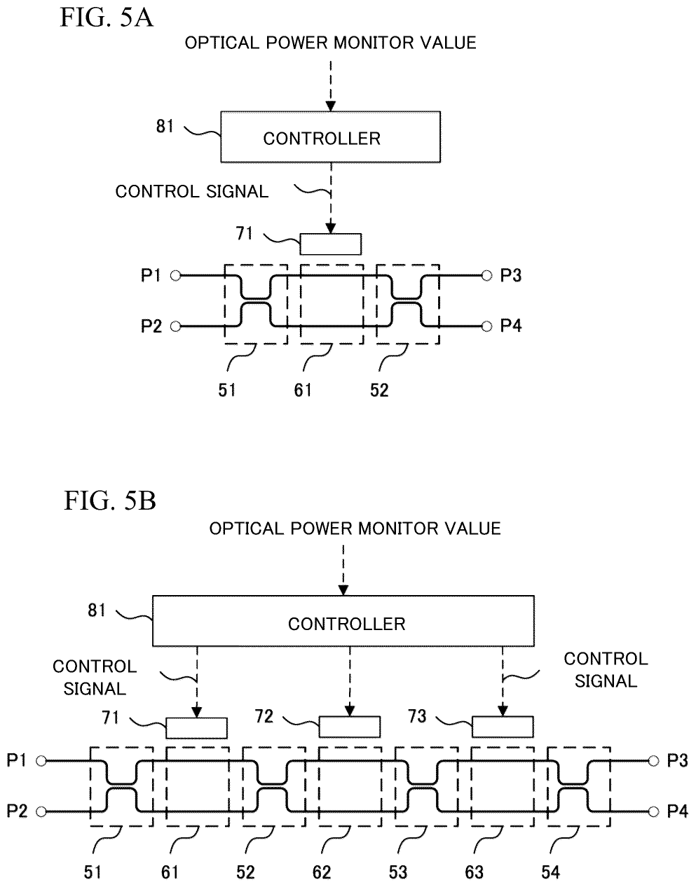

Each of the sub-optical circuits F includes a plurality of 2×2 couplers and phase shifters provided between the 2×2 couplers, as illustrated in FIG. 5A and FIG. 5B. Here, when the sub-optical circuit F includes N 2×2 couplers, the number of phase shifters is N−1.

In the example illustrated in FIG. 5A, the sub-optical circuit F includes two 2×2 couplers (51, 52). In this case, the sub-optical circuit F includes one phase shifter (61). The 2×2 coupler provided at the input end of the sub-optical circuit F may be called the “input coupler”. The 2×2 coupler provided at the output end of the sub-optical circuit F may be called the “output coupler”. In the example illustrated in FIG. 5A, the 2×2 coupler 51 is used as the “input coupler”, and the 2×2 coupler 52 is used as the “output coupler”.

The phase shifter 61 includes a pair of optical waveguides (upper arm waveguide and lower arm waveguide). The phase shifter 61 provides a predetermined phase difference between the upper arm waveguide and the lower arm waveguide. That is, the phase shifter 61 is configured so that when the input light of the phase shifter 61 is branched and guided to the upper arm waveguide and the lower arm waveguide, the difference between the phase of the light propagating through the upper arm waveguide and arriving at the output end and the phase of the light propagating through the lower arm waveguide and arriving at the output end is a predetermined value. Therefore, this phase difference corresponds to the difference between the optical path length of the upper arm waveguide and the optical path length of the lower arm waveguide. In the following description, this difference may be referred to as the “path length difference.”

The path length difference of the phase shifter 61 is adjusted, for example, by controlling the temperature of the optical waveguide that constitutes the phase shifter 61. In this embodiment, a heater 71 is provided near the optical waveguide that constitutes the phase shifter 61. The heater 71 is realized, for example, by an electrical resistor.

A controller 81 controls the path length difference of the phase shifter 61 based on the optical power monitor value indicating the output power of the sub-optical circuit F. The optical power monitor value is detected by an optical power monitor (not illustrated). The controller 81 controls the current of the heater 71 to increase or decrease the optical power monitor value. When the current of the heater 71 changes, the refractive index of the optical waveguide that constitutes the phase shifter 61 changes, and the path length difference of the phase shifter 61 is adjusted.

In the example illustrated in FIG. 5B, the sub-optical circuit F includes four 2×2 couplers (51-54) and three phase shifters (61-63). Each of the phase shifters 61-63 is provided between the 2×2 couplers. That is, the phase shifter 61 is provided between the 2×2 couplers 51 and 52, the phase shifter 62 is provided between the 2×2 couplers 52 and 53, and the phase shifter 63 is provided between the 2×2 couplers 53 and 54. In this case, the heater 71 and heaters 72 and 73 are provided near the phase shifters 61 to 63, respectively. The controller 81 adjusts the path length differences of the phase shifters 61 to 63 by controlling the currents of the heaters 71 to 73. The path length differences of the phase shifters 61 to 63 may be the same as each other, or may not be the same as each other. As an example, when the path length difference of the phase shifter provided closest to the input side (the phase shifter 61 in FIG. 5B) is ΔL, the path length differences of the other phase shifters are set to 2ΔL or 4ΔL.

As illustrated in FIG. 5A and FIG. 5B, each of the sub-optical circuits F has two input ports (P1, P2) and two output ports (P3, P4). The input ports P1 and P2 correspond to the input ports of the 2×2 coupler (i.e., an input coupler) provided at the input end of the sub-optical circuit. The output ports P3 and P4 correspond to the output ports of the 2×2 coupler (i.e., an output coupler) provided at the output end of the sub-optical circuit.

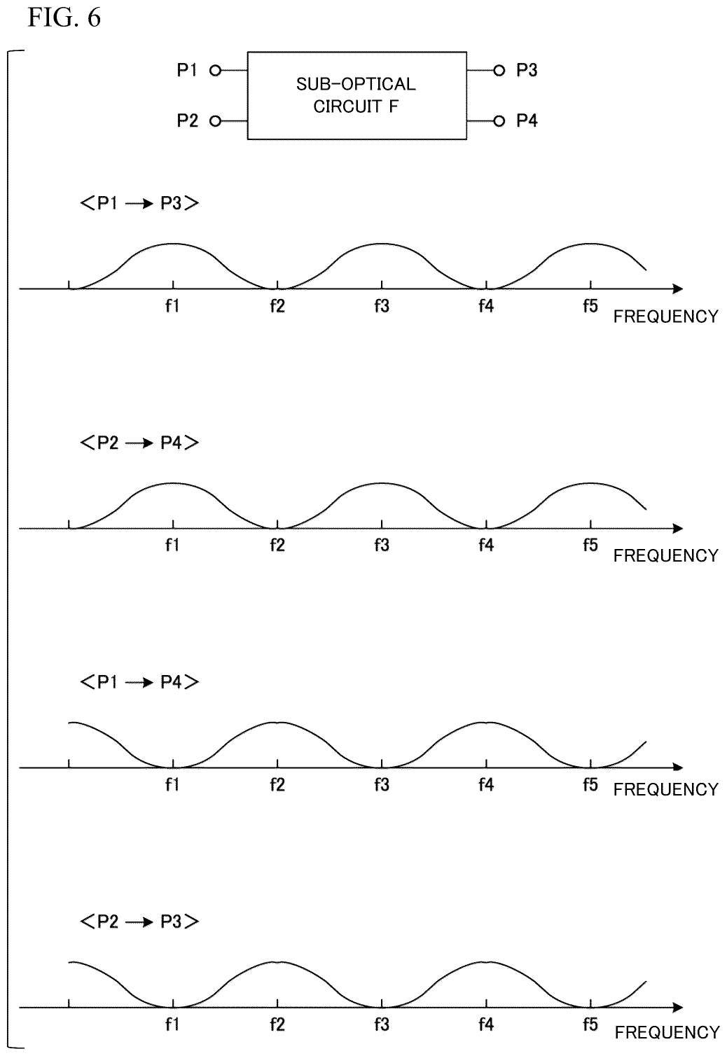

FIG. 6 is a diagram illustrating the transmission characteristics of the sub-optical circuit F. The sub-optical circuit F has periodic transmission characteristics. The period of the transmission characteristics is determined according to the path length difference generated by the phase shifter described with reference to FIG. 5A and FIG. 5B.

In the sub-optical circuit F, the transmission spectrum of the optical path between the ports P1 and P3 and the transmission spectrum of the optical path between the ports P2 and P4 are substantially the same. Moreover, the transmission spectrum of the optical path between the port P1 and the port P4 and the transmission spectrum of the optical path between the port P2 and the port P3 are substantially the same. On the other hand, the transmission spectrum of the optical path between the port P1 and the port P3 and the transmission spectrum of the optical path between the port P1 and the port P4 are complementary to each other. Moreover, the transmission spectrum of the optical path between the port P2 and the port P3 and the transmission spectrum of the optical path between the port P2 and the port P4 are c are complementary to each other.

For example, the optical signal f1 input through the port P1 is guided to the port P3 but not to the port P4. The optical signal f2 input through the port P1 is guided to the port P4 but not to the port P3. The optical signal f1 input through the port P2 is guided to the port P4 but not to the port P3. The optical signal f2 input through the port P2 is guided to the port P3 but not to the port P4.

It is also possible to input light from the port P3 or the port P4. In this case, the ports P1 and P2 are used as output ports. The transmission characteristics illustrated in FIG. 6 are substantially the same in the cases where the ports P1 and P2 are used as input ports and where the ports P3 and P4 are used as input ports.

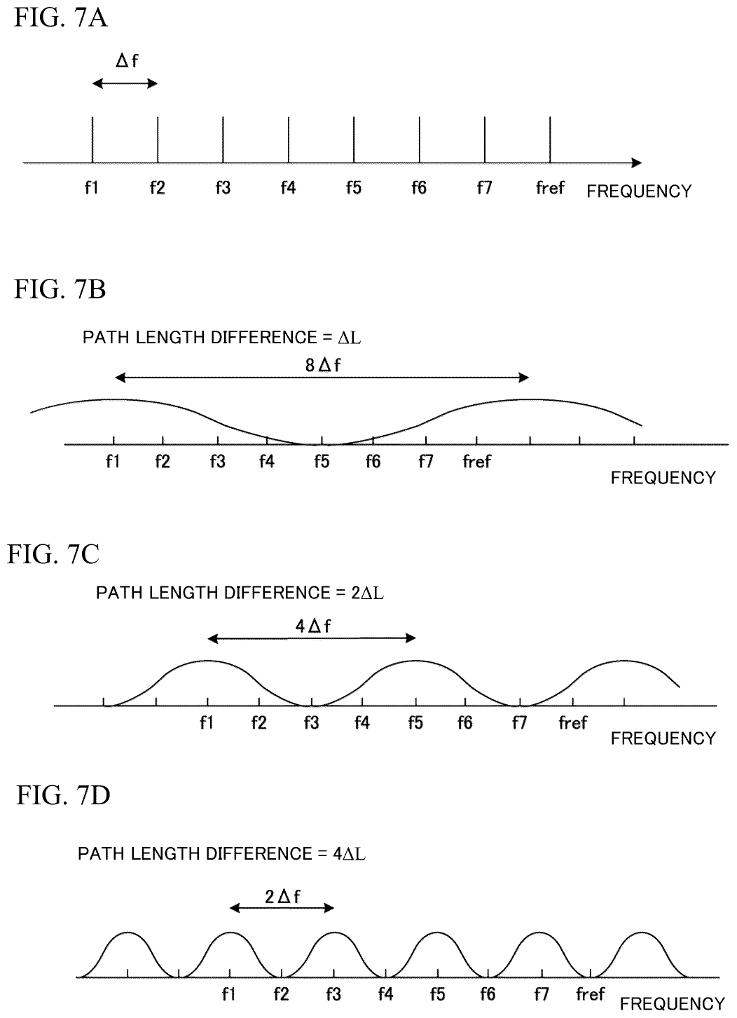

FIG. 7A to FIG. 7D illustrate examples of the filter characteristics of the sub-optical circuit F. In this embodiment, as illustrated in FIG. 7A, the subcarriers (or wavelength channels) of the WDM signal are arranged at a constant frequency interval Δf.

The phase shifter constituting the sub-optical circuit F can function as a frequency filter (or wavelength filter). For example, the phase shifter 61 illustrated in FIG. 5A or 5B has a filter characteristic that depends on the difference (i.e., the path length difference) between the optical path length of the upper arm waveguide and the optical path length of the lower arm waveguide. Specifically, the transmission characteristic of the phase shifter changes periodically with respect to the wavelength. This period depends on the path length difference of the phase shifter. In the following description, the path length difference of the phase shifter when the period of the transmission characteristic of the phase shifter is 8Δf is represented as “ΔL”. In this case, when the path length difference of a phase shifter 41 is controlled to ΔL, the period of the transmission characteristic of the phase shifter becomes 8Δf as illustrated in FIG. 7B. Δf represents, for example, the interval of the frequency grid of the WDM.

When the path length difference of the phase shifter increases, the period of the transmission characteristics of the phase shifter decreases, and when the path length difference of the phase shifter decreases, the period of the transmission characteristics of the phase shifter increases. Here, the period of the transmission characteristics of the phase shifter is essentially inversely proportional to the path length difference of the phase shifter. Therefore, when the path length difference of the phase shifter is controlled to 2ΔL, the period of the transmission characteristics of the phase shifter becomes 4Δf, as illustrated in FIG. 7C. Similarly, when the path length difference of the phase shifter is controlled to 4ΔL, the period of the transmission characteristics of the phase shifter becomes 2Δf, as illustrated in FIG. 7D.

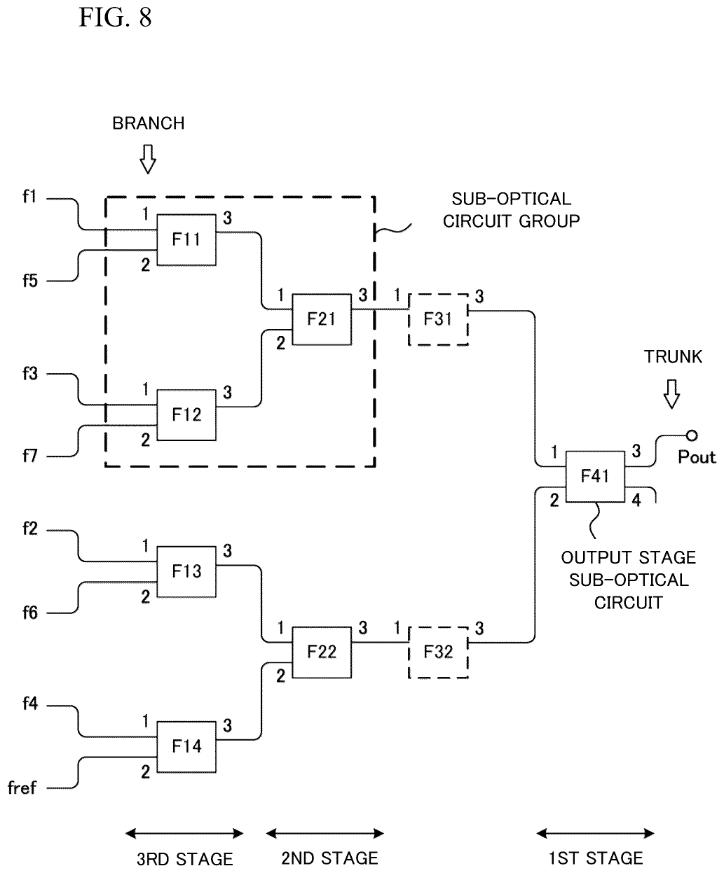

FIG. 8 illustrates a binary tree circuit composed of a plurality of sub-optical circuits. In this embodiment, the binary tree circuit is composed of the sub-optical circuits F11-F14, F21-F22, F31-F32, and F41. That is, the optical circuit of the binary tree structure is composed of the sub-optical circuits F11-F14, F21-F22, F31-F32, and F41. As will be explained later, the sub-optical circuits F31-F32 do not operate as combiners that combine modulated optical signals. Therefore, in the explanation of the binary tree circuit illustrated in FIG. 8, the sub-optical circuits F31-F32 are not included. The optical circuits also form a binary tree that includes three stages. Specifically, the sub-optical circuits F11-F14 form the first stage, the sub-optical circuits F21-F22 form the second stage, and the sub-optical circuits F31, F32, and F41 form the third stage. Alternatively, the sub-optical circuits F11 to F14 constitute the first stage, the sub-optical circuits F21 to F22 constitute the second stage, and the sub-optical circuit F41 constitutes the third stage.

The “trunk” of the binary tree circuit is the output port Pout of the optical transmitter 200. That is, the output port Pout connected to the output side of the sub-optical circuit F41 is the trunk of the binary tree circuit. In the following description, the sub-optical circuit connected to the output port Pout of the optical transmitter 200 may be called the “output stage sub-optical circuit”. In this embodiment, the output stage sub-optical circuit is the sub-optical circuit F41. The “branches (or leaves)” of the binary tree circuit are the input ports of the modulated optical signal. That is, the ports P1 and P2 of each of the sub-optical circuits F11 to F14 correspond to the branches and leaves, respectively.

In the path from the trunk to the leaves of the binary tree circuit, an output stage sub-optical circuit (i.e., the sub-optical circuit F41) is provided in the first stage. In this case, the sub-optical circuits F21 and F22 are provided in the second stage, and the sub-optical circuits F11 to F14 are provided in the third stage. The period of the transmission characteristics of the sub-optical circuits provided in each stage is the same. Specifically, the period of the transmission characteristics of each of the sub-optical circuits F21 and F22 is 4Δf, and the period of the transmission characteristics of each of the sub-optical circuits F11 to F14 is 8Δf. In addition, the period of the transmission characteristics of the sub-optical circuit provided in the (i+1)-th stage is twice the period of the transmission characteristics of the sub-optical circuit provided in the i-th stage. “i” is an integer equal to or greater than 1.

The binary tree circuit is composed of a plurality of sub-optical circuit groups. One sub-optical circuit group is composed of one sub-optical circuit F provided in the i-th stage and two sub-optical circuits F provided in the (i+1)-th stage. The sub-optical circuit group enclosed in a dashed line in FIG. 8 is composed of the sub-optical circuit F21 provided in the second stage and the sub-optical circuits F11 and F12 provided in the third stage. The sub-optical circuits F22, F13, and F14 form one sub-optical circuit group, and the sub-optical circuits F41, F21, and F22 form one sub-optical circuit group.

In each sub-optical circuit group, the port P3 of one of the sub-optical circuits F provided in the (i+1)-th stage and the port P3 of the other sub-optical circuit F provided in the (i+1)-th stage are connected to the port P1 and the port P2 of the sub-optical circuit F provided in the i-th stage, respectively. For example, the port P3 of the sub-optical circuit F11 and the port P3 of the sub-optical circuit F12 are connected to the port P1 and the port P2 of the sub-optical circuit F21, respectively. Note that the port P4 of each sub-optical circuit F is not used to configure a binary tree circuit.

Modulated optical signals are input from each branch of the binary tree circuit configured as above. Then, a plurality of modulated optical signals are multiplexed to generate a WDM signal.

Returning to the explanation of FIG. 3, the modulated optical signals f1 and f5 are input to the ports P1 and P2 of the sub-optical circuit F11, respectively. The modulated optical signals f3 and f7 are input to the ports P1 and P2 of the sub-optical circuit F12, respectively. The modulated optical signals f2 and f6 are input to the ports P1 and P2 of the sub-optical circuit F13, respectively. The modulated optical signal f4 and the reference optical signal fref are input to the ports P1 and P2 of the sub-optical circuit F14, respectively.

The port P3 of the sub-optical circuit F11 is optically coupled to the port P1 of the sub-optical circuit F21, the port P3 of the sub-optical circuit F12 is optically coupled to the port P2 of the sub-optical circuit F21, the port P3 of the sub-optical circuit F13 is optically coupled to the port P1 of the sub-optical circuit F22, and the port P3 of the sub-optical circuit F14 is optically coupled to the port P2 of the sub-optical circuit F22. An optical monitor M11 is connected to the port P4 of the sub-optical circuit F11, an optical monitor M12 is connected to the port P4 of the sub-optical circuit F12, an optical monitor M13 is connected to the port P4 of the sub-optical circuit F13, and an optical monitor M14 is connected to the port P4 of the sub-optical circuit F14.

The port P3 of the sub-optical circuit F21 is optically coupled to the port P1 of the sub-optical circuit F31, and the port P3 of the sub-optical circuit F22 is optically coupled to the port P1 of the sub-optical circuit F32. An optical monitor M21 is connected to the port P4 of the sub-optical circuit F21, and an optical monitor M22 is connected to the port P4 of the sub-optical circuit F22.

The port P3 of the sub-optical circuit F31 is optically coupled to the port P1 of the sub-optical circuit F41, and the port P3 of the sub-optical circuit F32 is optically coupled to the port P2 of the sub-optical circuit F41. An optical monitor M31 is connected to the port P3 of the sub-optical circuit F31, and an optical monitor M32 is connected to the port P3 of the sub-optical circuit F32. Furthermore, an optical monitor M33 is connected to the port P1 of the sub-optical circuit F31, and an optical monitor M34 is connected to the port P1 of the sub-optical circuit F32.

The port P3 of the sub-optical circuit F41 is optically coupled to the output port Pout of the optical transmitter 200. An optical monitor M41 is connected to the port P3 of the sub-optical circuit F41. An optical monitor M42 is connected to the port P1 of the sub-optical circuit F41.

The reference optical signal fref generated by the high-precision light source LD8 and the optical modulator Mod8 is guided to the port P4 of the sub-optical circuit F41. In this embodiment, the reference optical signal fref is also guided to the port P4 of the sub-optical circuit F31 and the port P4 of the sub-optical circuit F32.

The optical paths between the optical modulator Mod and the sub-optical circuits F, and the optical paths between the sub-optical circuits F, are each realized by, for example, an optical waveguide. In this case, the optical waveguide is composed of, for example, a Si nanowire waveguide core and a SiO₂ waveguide clad.

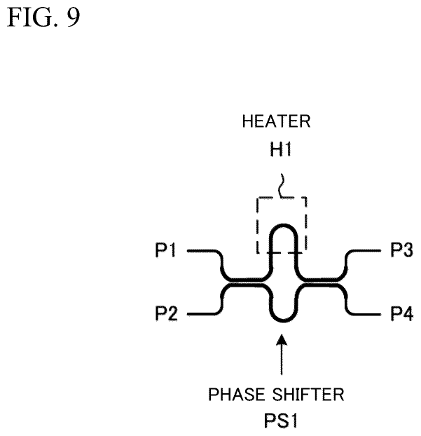

FIG. 9 illustrates an example of the configuration of the sub-optical circuit F11. In this example, the sub-optical circuit F11 includes one phase shifter (PS1). This phase shifter is composed of a pair of waveguides (upper arm waveguide and lower arm waveguide). The difference between the optical path length of the upper arm waveguide and the optical path length of the lower arm waveguide (i.e., the path length difference) is approximately ΔL. When the path length difference is ΔL, the period of the transmission characteristic of the sub-optical circuit F11 is 8Δf, as described with reference to FIG. 7B.

A heater (H1) is provided near at least one of the upper arm waveguide or the lower arm waveguide. The current supplied to the heater is controlled by the controller C11. Here, the refractive index or optical path length of the optical waveguide depends on the temperature. Therefore, by controlling the heater, the path length difference of the sub-optical circuit F11 can be adjusted and the transmission spectrum can be set to a target state.

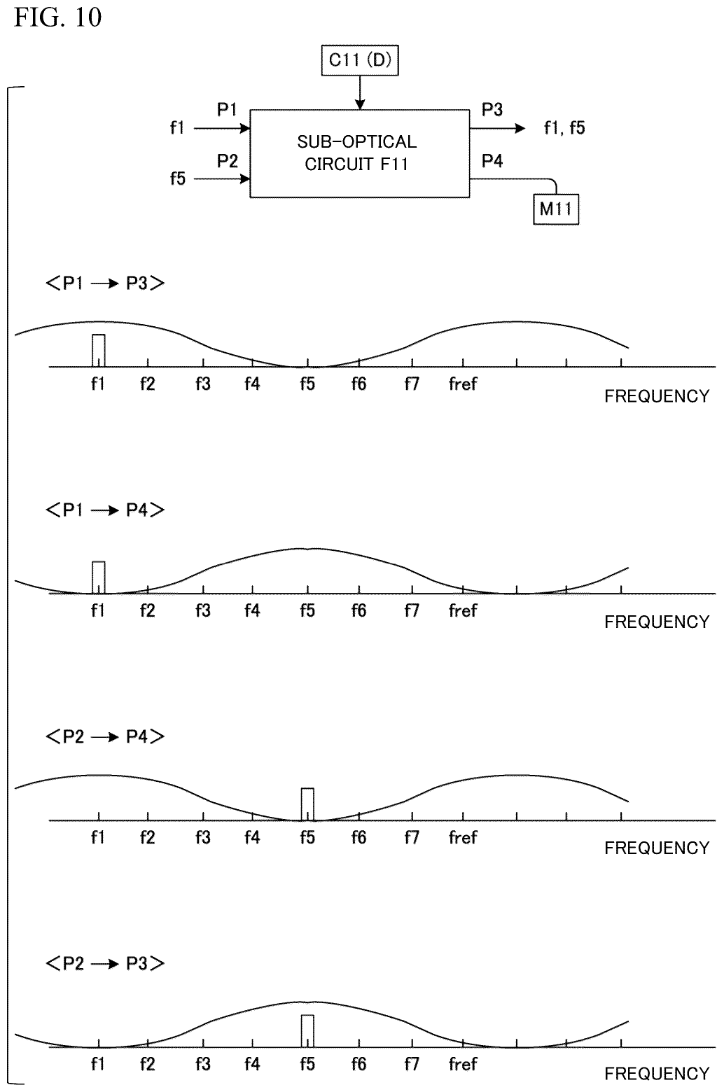

FIG. 10 illustrates an example of the operation of the sub-optical circuit F11. The optical signals f1 and f5 are input to the ports P1 and P2 of the sub-optical circuit F11, respectively. The optical monitor M11 is connected to the port P4. The controller C11 controls the filter characteristics (i.e., the transmission spectrum) of the sub-optical circuit F11.

The sub-optical circuit F11 is configured so that the path length difference is approximately ΔL. Therefore, the period of the transmission characteristic of the sub-optical circuit F11 is approximately 8Δf. In other words, the sub-optical circuit F11 has the transmission spectrum illustrated in FIG. 10.

The optical signal f1 is input to the port P1. Here, when the transmission spectrum of the sub-optical circuit F11 is set to a target state, the optical path between the ports P1 and P3 passes light of frequency f1. On the other hand, the optical path between the port P1 and the port P4 does not pass light of frequency f1. Therefore, the optical signal f1 input through the port P1 is output from the port P3.

The optical signal f5 is input to the port P2. Here, when the transmission spectrum of the sub-optical circuit F11 is set to the target state, the optical path between the port P2 and the port P3 passes light of frequency f5. On the other hand, the optical path between the port P2 and the port P4 does not pass light of frequency f5. Therefore, the optical signal f5 input through the port P2 is output from the port P3.

In this way, the sub-optical circuit F11 multiplexes the optical signal f1 and the optical signal f5 and outputs the multiplexed signal through the port P3. Note that in the following description, the optical signal obtained by multiplexing the optical signal fi and the optical signal fj may be referred to as the “optical signal fi+fj”. In other words, the optical signal f1+f5 is output through the port P3.

At this time, if the transmission spectrum of the sub-optical circuit F11 is adjusted to the target state, no optical signal is output through the port P4. In other words, if the sub-optical circuit F11 is controlled so that the output optical power of the port P4 is reduced, the transmission spectrum of the sub-optical circuit F11 approaches the target state. Therefore, the optical monitor M11 monitors the output optical power of the port P4 of the sub-optical circuit F11. Then, the controller C11 controls the phase shifter of the sub-optical circuit F11 so as to reduce the optical power monitor value obtained by the optical monitor M11. Specifically, the controller C11 adjusts the path length difference of the sub-optical circuit F11, for example, by controlling the current supplied to the heater (the heater 71 in FIG. 5A and FIG. 5B) provided near the sub-optical circuit F11. As a result, the transmission spectrum of the sub-optical circuit F11 is set to the target state, and the loss of the optical signals f1 and f5 is reduced.

In the above embodiment, the phase shifter is controlled based on the output power of the port P4, but the embodiment of the present invention is not limited to this configuration. For example, the controller C11 may control the phase shifter based on the output power of the port P3. In this case, however, the controller C11 controls the phase shifter so that the output power of port P3 is increased.

The configuration and operation of the sub-optical circuits F12 to F14 are substantially the same as the configuration and operation of the sub-optical circuit F11. That is, the sub-optical circuit F12 multiplexes the optical signal f3 and the optical signal f7 to output the optical signal f3+f7. The sub-optical circuit F13 multiplexes the optical signal f2 and the optical signal f6 to output the optical signal f2+f6. The sub-optical circuit F14 multiplexes the optical signal f4 and the reference optical signal fref to output the optical signal f4+fref.

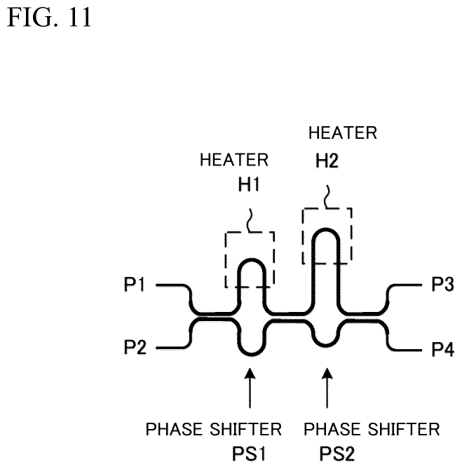

FIG. 11 illustrates an example of the configuration of the sub-optical circuit F21. In this embodiment, the sub-optical circuit F21 includes two phase shifters (PS1, PS2). The path length difference of the phase shifter PS1 is approximately ΔL, and the period of the transmission characteristic is 8Δf. The path length difference of the phase shifter PS2 is approximately 2ΔL, and the period of the transmission characteristic is 4Δf. Therefore, when the frequency at which the transmission characteristic peak of the phase shifter PS1 appears coincides with the frequency at which the transmission characteristic peak of the phase shifter PS2 appears, the period of the transmission characteristic of the sub-optical circuit F21 is 4Δf.

Heaters H1 and H2 are provided for the phase shifters PS1 and PS2, respectively. The controller C21 controls the heaters H1 and H2 individually. This adjusts the path length difference of the sub-optical circuit F21, and sets the transmission spectrum to a target state.

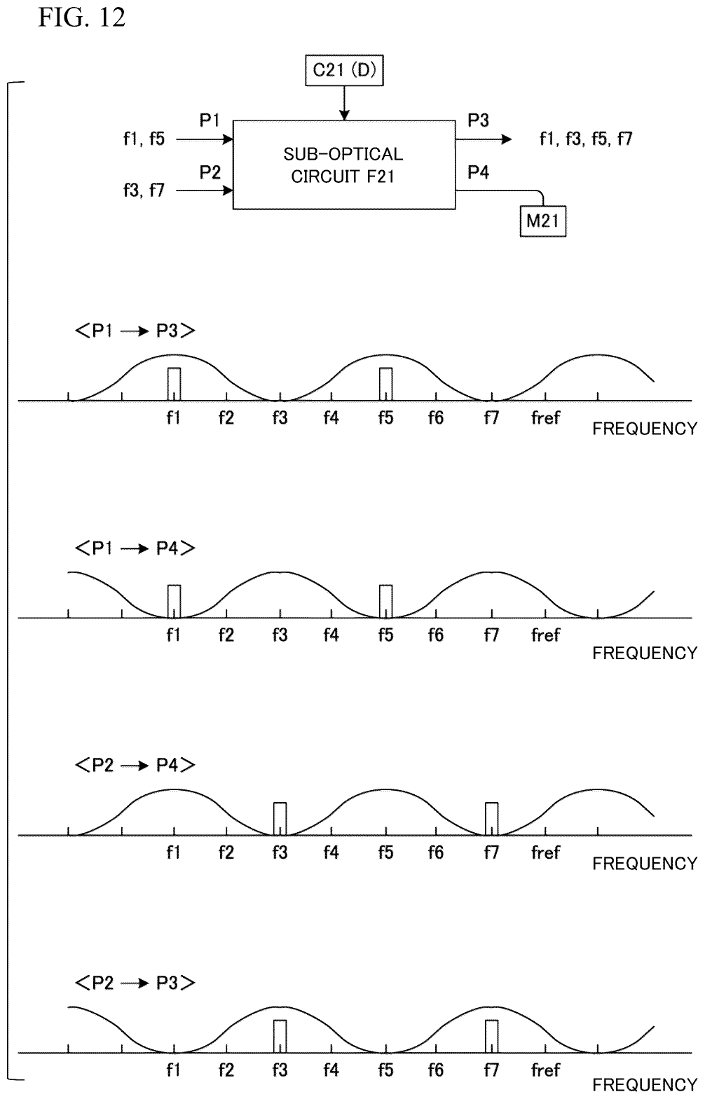

FIG. 12 illustrates an example of the operation of the sub-optical circuit F21. Note that the optical signal f1+f5 is input to the port P1, and the optical signal f3+f7 is input to the port P2. An optical monitor M21 is connected to the port P4. A controller C21 controls the filter characteristics of the sub-optical circuit F21.

The sub-optical circuit F21 includes a phase shifter with a path length difference of approximately 2ΔL. Therefore, the period of the transmission characteristics of the sub-optical circuit F21 is approximately 4Δf. In other words, the sub-optical circuit F21 has the transmission spectrum illustrated in FIG. 12.

The optical signal f1+f5 is input to the port P1. Here, when the transmission spectrum of the sub-optical circuit F21 is set to a target state, the optical path between the port P1 and the port P3 passes light of frequencies f1 and f5. On the other hand, the optical path between the port P1 and the port P4 does not pass light of frequencies f1 and f5. Therefore, the optical signal f1+f5 input through the port P1 is output from the port P3.

The optical signal f3+f7 is input to the port P2. Here, when the transmission spectrum of the sub-optical circuit F21 is set to the target state, the optical path between the port P2 and the port P3 passes light of frequencies f3 and f7. On the other hand, the optical path between the port P2 and the port P4 does not pass light of frequencies f3 and f7. Therefore, the optical signal f3+f7 input through the port P2 is output from the port P3.

In this way, the sub-optical circuit F21 multiplexes the optical signals f1+f5 and f3+f7 and outputs the multiplexed signal through the port P3. That is, the optical signal f1+f3+f5+f7 is output through the port P3.

At this time, if the transmission spectrum of the sub-optical circuit F21 is adjusted to the target state, no optical signal is output through the port P4. In other words, if the sub-optical circuit F21 is controlled so that the output optical power of the port P4 is reduced, the transmission spectrum of the sub-optical circuit F21 approaches the target state. Therefore, the optical monitor M21 monitors the output optical power of the port P4 of the sub-optical circuit F21. Then, the controller C21 controls the phase shifter of the sub-optical circuit F21 so as to reduce the optical power monitor value obtained by the optical monitor M21. As a result, the transmission spectrum of the sub-optical circuit F21 is set to the target state, and the loss of the optical signals f1, f3, f5, and f7 is reduced.

In the above embodiment, the phase shifter is controlled based on the output power of the port P4, but the embodiment of the present invention is not limited to this configuration. For example, the controller C21 may control the phase shifter based on the output power of the port P3. However, in this case, the controller C21 controls the phase shifters so that the output power of the port P3 is increased.

The configuration and operation of the sub-optical circuit F22 are substantially the same as those of the sub-optical circuit F21. That is, the sub-optical circuit F22 combines optical signals f2+f6 and f4+fref to output the optical signal f2+f4+f6+fref.

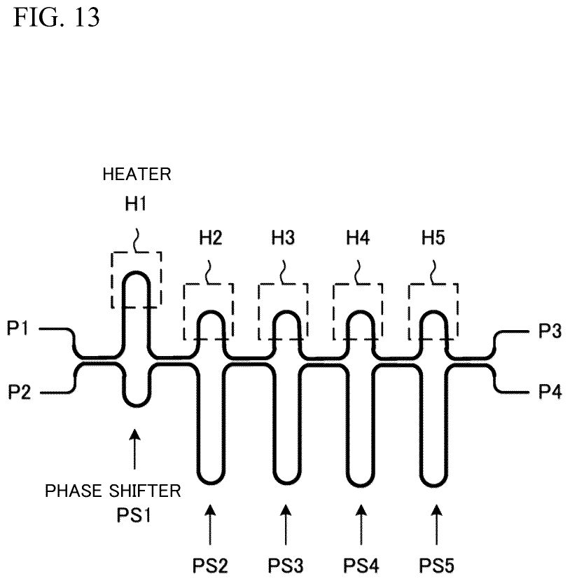

FIG. 13 illustrates an example of the configuration of the sub-optical circuit F31. In this embodiment, the sub-optical circuit F31 includes five phase shifters (PS1 to PS5). The path length difference of the phase shifter PS1 is approximately 2ΔL, and the period of the transmission characteristic is 4Δf. The path length difference of each of the phase shifters PS2 to PS5 is approximately 4ΔL, and the period of the transmission characteristic is 2Δf. Therefore, when the frequency at which the transmission characteristic peak appears due to phase shifter PS1 coincides with the frequency at which the transmission characteristic peak appears due to phase shifters PS2 to PS5, the period of the transmission characteristic of sub-optical circuit F31 is 2Δf.

Heaters H1 to H5 are provided for the phase shifters PS1 to PS5, respectively. Then, controller C31 controls the heaters H1 to H5 individually. This adjusts the path length difference of the sub-optical circuit F31, and sets the transmission spectrum to a target state.

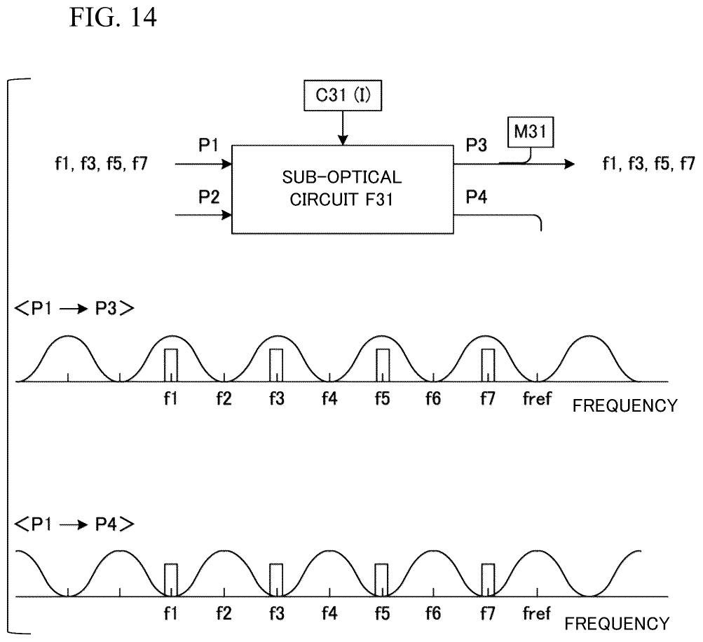

FIG. 14 illustrates an example of the operation of the sub-optical circuit F31. Note that the optical signal f1+f3+f5+f7 is input to the port P1. An optical monitor M31 is connected to the port P3. The controller C31 controls the filter characteristics of the sub-optical circuit F31.

The sub-optical circuit F31 includes a phase shifter with a path length difference of approximately 4ΔL. Therefore, the period of the transmission characteristics of the sub-optical circuit F31 is approximately 2Δf. In other words, the sub-optical circuit F31 has the transmission spectrum illustrated in FIG. 14.

The optical signal f1+f3+f5+f7 is input to the port P1. Here, when the transmission spectrum of the sub-optical circuit F31 is set to the target state, the optical path between the port P1 and the port P3 passes light of frequencies f1, f3, f5, and f7. On the other hand, the optical path between the port P1 and the port P4 does not allow light of frequencies f1, f3, f5, and f7 to pass. Therefore, the optical signal f1+f3+f5+f7 input through the port P1 is output from the port P3.

In this way, the optical signal f1+f3+f5+f7 passes through the sub-optical circuit F31. At this time, the spectrum of each of the optical signals f1, f3, f5, f7 is shaped by passing through the sub-optical circuit F31.

The reference optical signal fref is input to the port P4 of the sub-optical circuit F31. Therefore, the optical monitor M31 that monitors the output power of the sub-optical circuit F31 is connected to the port P3, not the port P4.

If the transmission spectrum of the sub-optical circuit F31 is adjusted to the target state, the optical signal f1+f3+f5+f7 is guided from the port P1 to the port P3. In other words, if the sub-optical circuit F31 is controlled so that the output optical power of the port P3 is increased, the transmission spectrum of the sub-optical circuit F31 approaches the target state. Therefore, the optical monitor M31 monitors the output optical power of the port P3 of the sub-optical circuit F31. Then, the controller C31 controls the phase shifter of the sub-optical circuit F31 so as to increase the optical power monitor value obtained by the optical monitor M31. As a result, the transmission spectrum of the sub-optical circuit F31 is set to the target state, and the loss of the optical signals f1, f3, f5, and f7 is reduced.

The configuration and operation of the sub-optical circuit F32 are substantially the same as those of the sub-optical circuit F31. That is, the optical signal f2+f4+f6+fref passes through the sub-optical circuit F32. At this time, the spectra of the optical signals f2, f4, f6, and fref are shaped.

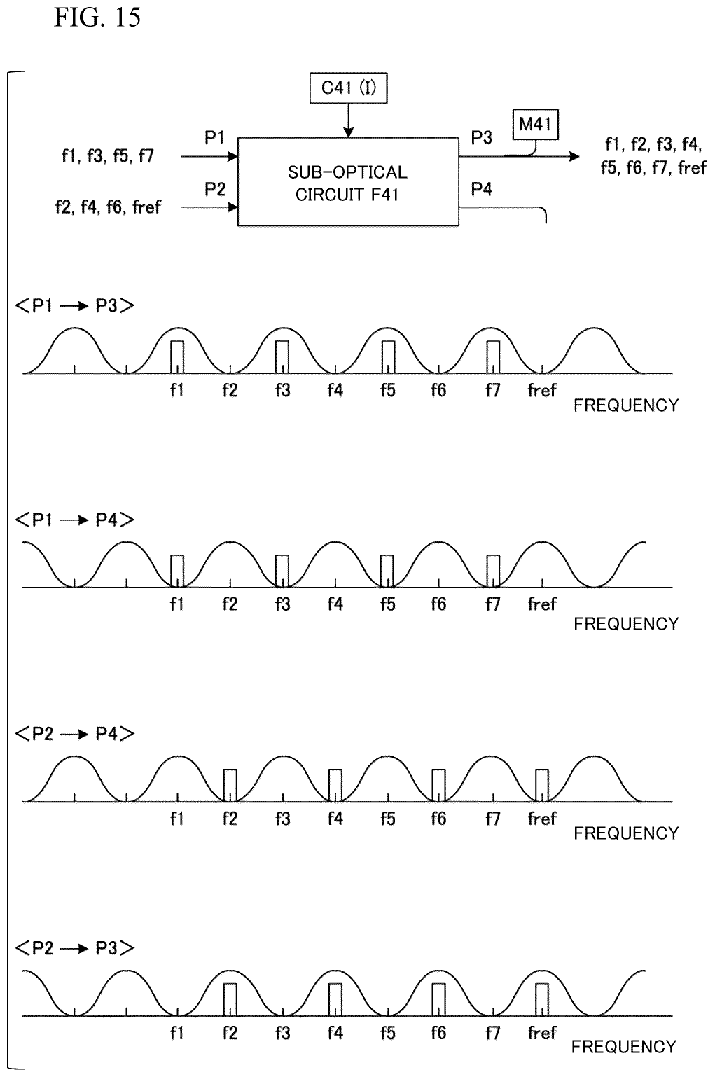

FIG. 15 illustrates an example of the operation of the sub-optical circuit F41. Note that the optical signal f1+f3+f5+f7 is input to the port P1, and the optical signal f2+f4+f6+fref is input to the port P2. An optical monitor M41 is connected to the port P3. A controller C41 controls the filter characteristics of the sub-optical circuit F41.

The sub-optical circuit F41 includes a phase shifter with a path length difference of approximately 4ΔL. Therefore, the period of the transmission characteristics of the sub-optical circuit F41 is approximately 2Δf. That is, the sub-optical circuit F41 has the transmission spectrum illustrated in FIG. 15.

The optical signal f1+f3+f5+f7 is input to the port P1. Here, when the transmission spectrum of sub-optical circuit F41 is set to the target state, the optical path between the port P1 and the port P3 passes light of frequencies f1, f3, f5, and f7. On the other hand, the optical path between the port P1 and the port P4 does not pass light of frequencies f1, f3, f5, and f7. Therefore, the optical signal f1+f3+f5+f7 input through the port P1 is output from the port P3.

The optical signal f2+f4+f6+fref is input to the port P2. When the transmission spectrum of the sub-optical circuit F41 is set to the target state, the optical path between the port P2 and the port P3 passes light of frequencies f2, f4, f6, and fref. On the other hand, the optical path between the port P2 and the port P4 does not pass light of frequencies f2, f4, f6, and fref. Therefore, the optical signal f2+f4+f6+fref input through the port P2 is output from the port P3.

In this way, the sub-optical circuit F41 multiplexes the optical signals f1+f3+f5+f7 and f2+f4+f6+fref and outputs the multiplexed signal through the port P3. That is, the optical signal f1+f2+f3+f4+f5+f6+f7+fref is output through the port P3.

The reference optical signal fref is input to the port P4 of the sub-optical circuit F41. Therefore, the optical monitor M41, which monitors the output power of the sub-optical circuit F41, is connected to the port P3, not the port P4.

If the transmission spectrum of the sub-optical circuit F41 is adjusted to the target state, the optical signals f1 to f7 and fref are all output through the port P3. In other words, if the phase shifter of the sub-optical circuit F41 is controlled so that the output optical power of the port P3 is increased, the transmission spectrum of the sub-optical circuit F41 approaches the target state. Therefore, the optical monitor M41 monitors the output optical power of the port P3 of the sub-optical circuit F41. Then, the controller C41 controls the phase shifter of the sub-optical circuit F41 so as to increase the optical power monitor value obtained by the optical monitor M41. As a result, the transmission spectrum of the sub-optical circuit F41 is set to the target state, and the loss for each of the optical signals f1 to f7 and fref is reduced.

In this embodiment, the configuration of the sub-optical circuit F41 is substantially the same as that of a sub-optical circuit 31. That is, as illustrated in FIG. 13, the sub-optical circuit F41 includes the phase shifters PS1 to PS5 and the heaters H1 to H5. The controller C41 individually adjusts the path length differences of the phase shifters PS1 to PS5 by individually controlling the heaters H1 to H5.

In the optical transmitter 200 configured as above, the reference optical signal fref generated by the high-precision light source LD8 and the optical modulator Mod8 is guided to the port P2 of the sub-optical circuit F14, and also to the port P4 of the sub-optical circuit F41, the port P4 of the sub-optical circuit F31, and the port P4 of the sub-optical circuit F32. Therefore, the operation of the sub-optical circuits F41, F31, and F32 with respect to the reference optical signal fref will be explained.

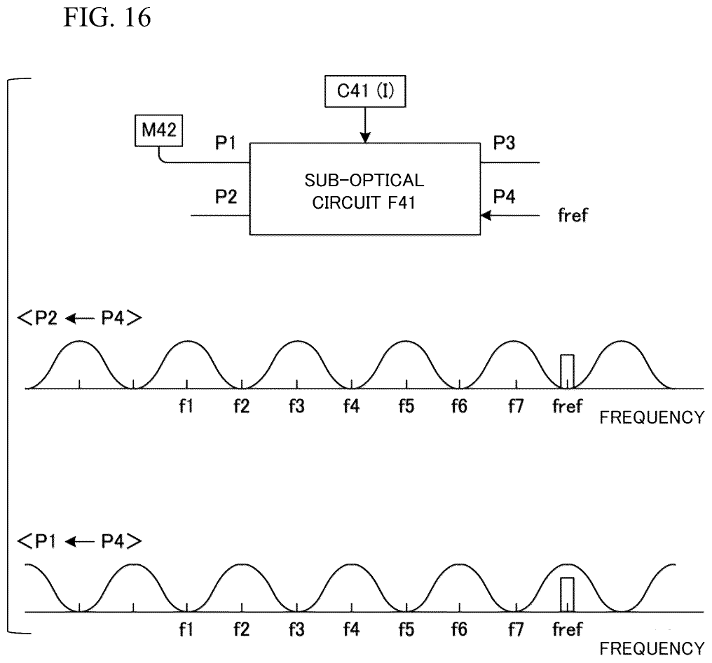

FIG. 16 illustrates an example of the operation of the sub-optical circuit F41 with respect to the reference optical signal fref. The reference optical signal fref is input through the port P4. An optical monitor M42 is connected to the port P1. The controller C41 controls the filter characteristics of the sub-optical circuit F41.

In the sub-optical circuit F41, the transmission characteristics for the light traveling from the input ports (P1, P2) to the output ports (P3, P4) and the transmission characteristics for the light traveling from the output ports (P3, P4) to the input ports (P1, P2) are the same. That is, the sub-optical circuit F41 has the transmission spectrum illustrated in FIG. 16 for the reference optical signal fref.

The reference optical signal fref is input to the port P4. Here, when the transmission spectrum of the sub-optical circuit F41 is set to the target state, the optical path between the port P4 and the port P1 passes light of frequency fref. On the other hand, the optical path between the port P4 and the port P2 does not pass light of frequency fref. Therefore, the reference optical signal fref input through the port P4 is output from the port P1.

Therefore, the optical monitor M42 monitors the output optical power of the port P1 of the sub-optical circuit F41. Then, the controller C41 controls the phase shifter of the sub-optical circuit F41 so as to increase the optical power monitor value obtained by the optical monitor M42. As a result, the transmission spectrum of the sub-optical circuit F41 is calibrated based on the reference optical signal fref.

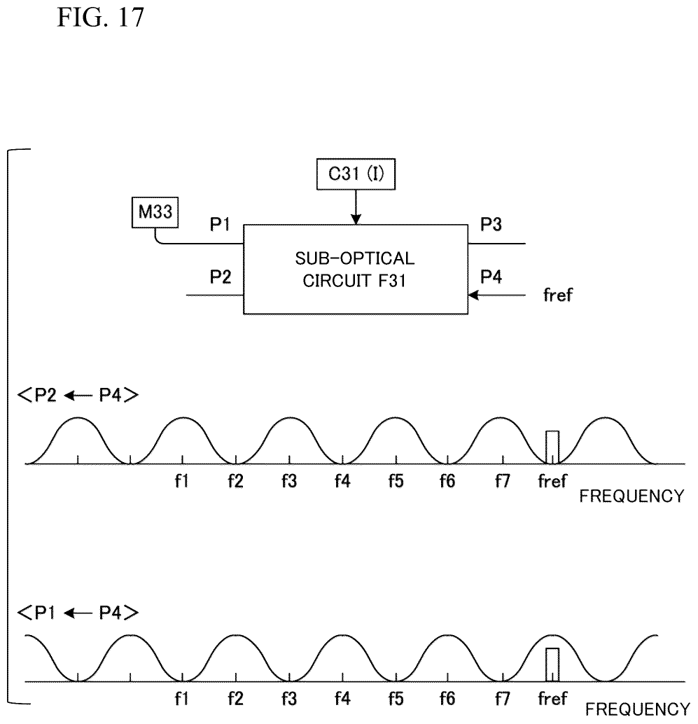

FIG. 17 illustrates an example of the operation of the sub-optical circuit F31 with respect to the reference optical signal fref. The reference optical signal fref is input through the port P4. An optical monitor M33 is connected to the port P1. The controller C31 controls the filter characteristics of the sub-optical circuit F31.

The operation of the sub-optical circuit F31 with respect to the reference optical signal fref is substantially the same as the operation of the sub-optical circuit F41 described with reference to FIG. 16. That is, the optical monitor M33 monitors the output optical power of the port P1 of the sub-optical circuit F31. The controller C31 controls the phase shifter of the sub-optical circuit F31 so as to increase the optical power monitor value obtained by the optical monitor M33. As a result, the transmission spectrum of the sub-optical circuit F31 is calibrated based on the reference optical signal fref.

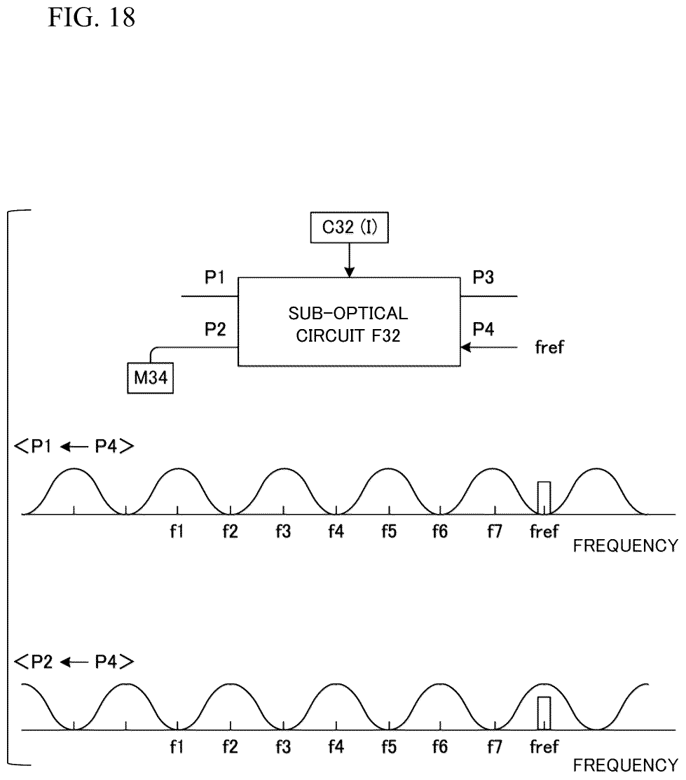

FIG. 18 illustrates an example of the operation of the sub-optical circuit F32 with respect to the reference optical signal fref. The reference optical signal fref is input through the port P4. An optical monitor M34 is connected to the port P1. The controller C32 controls the filter characteristics of the sub-optical circuit F32.

The operation of the sub-optical circuit F32 with respect to the reference optical signal fref is substantially the same as that of the sub-optical circuit F41 described with reference to FIG. 16. However, the sub-optical circuit F32 is set so that the frequencies f2, f4, f6, and fref pass between the ports P1 and P3 and between the ports P2 and P4, and the frequencies f2, f4, f6, and fref are blocked between the ports P1 and P4 and between the ports P2 and P3. That is, the transmission characteristics of the sub-optical circuit F32 are shifted by Δf illustrated in FIG. 7A to FIG. 7D with respect to the transmission characteristics of the sub-optical circuit F31 or the sub-optical circuit F41. Therefore, the sub-optical circuit F32 has the transmission spectrum illustrated in FIG. 18 with respect to the reference optical signal fref.

The reference optical signal fref is input to the port P4. Here, when the transmission spectrum of the sub-optical circuit F32 is set to the target state, the optical path between the port P4 and the port P2 passes light of frequency fref. On the other hand, the optical path between the port P4 and the port P1 does not pass light of frequency fref. Therefore, the reference optical signal fref input through the port P4 is output from the port P2.

Therefore, the optical monitor M34 monitors the output optical power of the port P2 of the sub-optical circuit F32. The controller C32 controls the phase shifter of the sub-optical circuit F32 so as to increase the monitor value obtained by the optical monitor M34. As a result, the transmission spectrum of the sub-optical circuit F32 is calibrated based on the reference optical signal fref.

In this way, the phase shifter of each of the sub-optical circuits F is adjusted. This allows each modulated optical signal to be multiplexed with small loss. In other words, a high-quality WDM signal is generated.

In addition to this, the optical transmitter 200 controls the oscillation frequency of each of the wavelength-tunable light sources LD1 to LD7. Furthermore, when the high-precision light source LD8 is a wavelength-tunable light source, the optical transmitter 200 may control the high-precision light source LD8 in addition to the wavelength-tunable light sources LD1 to LD7.

The tunable light source is controlled based on the optical power monitored in any one or more of the sub-optical circuits F11-F14, F21-F22, F31-F32, and F41. In the embodiment illustrated in FIG. 3, the tunable light source is controlled based on the optical power monitored in the sub-optical circuits F31, F32, and F41.

In the sub-optical circuit F31, the optical signals f1+f3+f5+f7 are output through the port P3. The optical monitor M31 monitors the output power of the port P3. The controller C31b controls the tunable light sources LD1, LD3, LD5, and LD7 based on the optical power monitor value obtained by the optical monitor M31. Here, it is considered that the optical power monitor value is maximized when the frequency interval of the optical signals f1, f3, f5, and f7 is 2Δf. Therefore, the controller C31b controls the wavelength-tunable light sources LD1, LD3, LD5, and LD7 so that the optical power monitor value obtained by the optical monitor M31 becomes large.

In the sub-optical circuit F32, the optical signal f2+f4+f6+fref is output through the port P3. The optical monitor M32 monitors the output power of the port P3. A controller C32b controls the wavelength-tunable light sources LD2, LD4, and LD6 based on the optical power monitor value obtained by the optical monitor M32. Here, it is considered that the optical power monitor value is maximized when the frequency interval of the optical signals f1, f3, f5, and fref is 2Δf. Therefore, the controller C32b controls the wavelength-tunable light sources LD2, LD4, and LD6 so that the optical power monitor value obtained by the optical monitor M32 becomes large.

In the sub-optical circuit F41, the optical signal f1+f2+f3+f4+f5+f6+f7+fref is output through the port P3. The optical monitor M41 monitors the output power of the port P3. A controller C41b controls the tunable light sources LD1 to LD7 based on the optical power monitor value obtained by the optical monitor M41. Here, it is considered that the optical power monitor value is maximum when the frequency interval between the optical signals f1 to f7 and fref is Δf. Therefore, the controller C41b controls the tunable light sources LD1 to LD7 so that the optical power monitor value obtained by the optical monitor M41 becomes large.

When the tunable light sources LD1 to LD7 are controlled as described above, the optical signals f1 to f7 and fref are arranged at a frequency interval Δf. Here, the reference optical signal fref is generated using the high-precision light source LD8. In addition, the high-precision light source LD8 is configured to output continuous light of a pre-specified reference frequency (for example, one of a plurality of frequencies defined as the frequency grid of WDM transmission). Therefore, each of the optical signals f1 to f7 is also arranged on the frequency grid of WDM transmission.

As a result, high-quality WDM transmission is realized. Here, only one of the multiple light sources provided in the optical transmitter 200 is a high-precision light source, and the other light sources are realized by inexpensive wavelength-tunable light sources. Therefore, it is possible to realize high-quality WDM transmission while suppressing the cost of the optical transmitter 200.

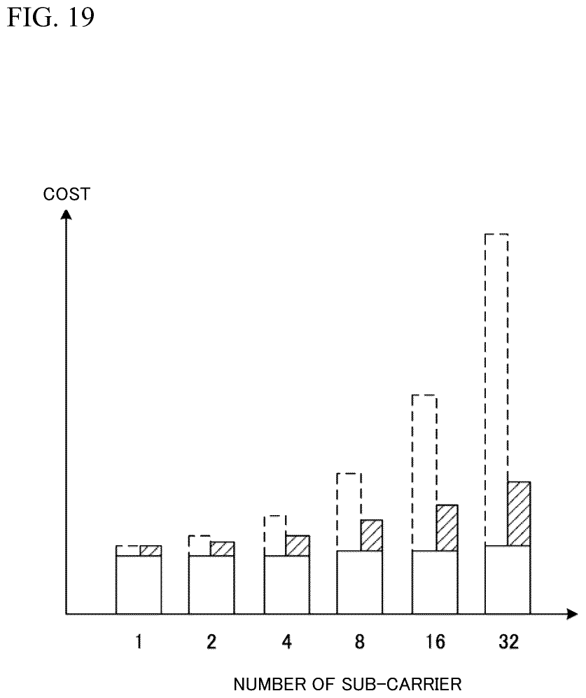

FIG. 19 illustrates an example of the effect of cost reduction according to an embodiment of the present invention. In FIG. 19, the shaded area represents the cost of the light sources (wavelength-tunable light source and high-precision light source) in the configuration according to the embodiment of the present invention. The dashed line represents the cost when all light sources are high-precision light sources. In this way, according to the embodiment of the present invention, it is possible to reduce the cost of the optical transmitter or optical transceiver. This effect is particularly noticeable when the number of subcarriers (or the number of wavelength channels) is large.

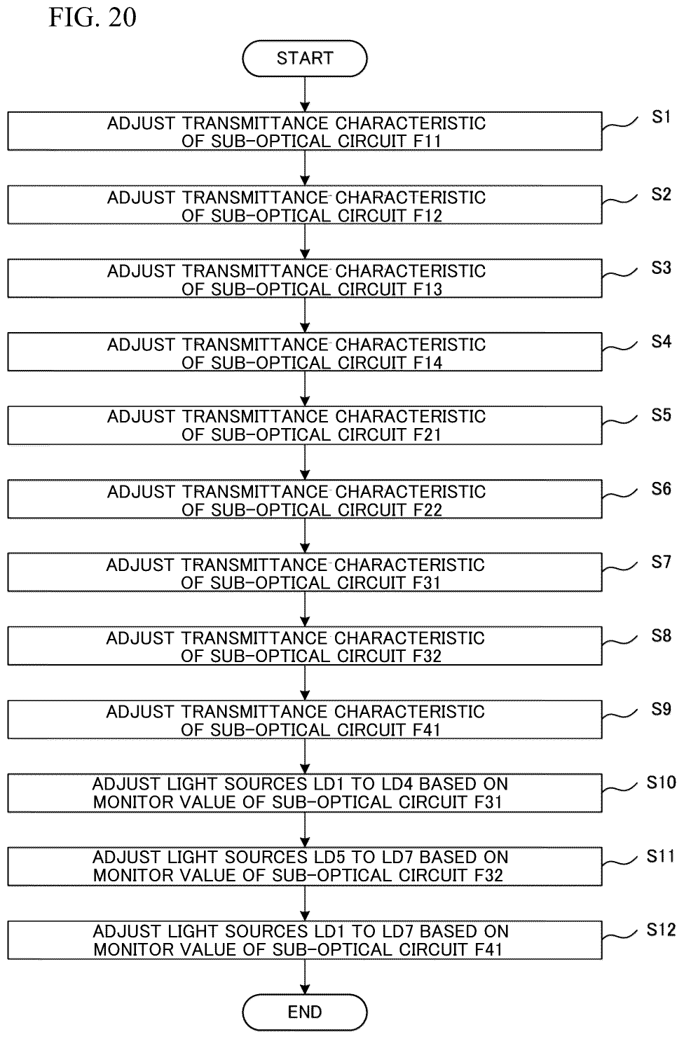

FIG. 20 is a flowchart of an example of a control method used in the optical transmitter 200. The process of this flowchart is executed, for example, before the optical transmitter 200 starts data transmission. The process of this flowchart may also be executed when the temperature around the optical transmitter 200 changes. Furthermore, the process of this flowchart may be executed periodically in consideration of aging deterioration of the optical device.

In S1, the controller C11 adjusts the transmission characteristics of the sub-optical circuit F11 based on the optical power monitor value obtained by the optical monitor M11. Here, the sub-optical circuit F11 is equipped with the heater H1 as illustrated in FIG. 9. In this case, the controller C11 controls the heater H1 so that the optical power monitor value becomes smaller. In addition, the controller C11 may control the oscillation frequency of the wavelength-tunable light source corresponding to the modulated optical signal input to the sub-optical circuit F11 so that the optical power monitor value becomes larger. In this embodiment, the controller C11 may adjust the oscillation frequency of the wavelength-tunable light sources LD1 and LD5.

In S2, the controller C12 adjusts the transmission characteristics of the sub-optical circuit F12 based on the optical power monitor value obtained by the optical monitor M12. The operation of the controller C12 is substantially the same as that of the controller C11. That is, the controller C12 controls the heater H1 so that the optical power monitor value becomes smaller. In addition, the controller C12 may adjust the oscillation frequency of the wavelength-tunable light sources LD3 and LD7 so that the optical power monitor value becomes larger.

In S3, the controller C13 adjusts the transmission characteristics of the sub-optical circuit F13 based on the optical power monitor value obtained by the optical monitor M13. The operation of the controller C13 is substantially the same as that of the controller C11. That is, the controller C13 controls the heater H1 so that the optical power monitor value becomes smaller. In addition, the controller C13 may adjust the oscillation frequency of the wavelength-tunable light sources LD2 and LD6 so that the optical power monitor value becomes larger.

In S4, the controller C14 adjusts the transmission characteristics of the sub-optical circuit F14 based on the optical power monitor value obtained by the optical monitor M14. The operation of the controller C14 is substantially the same as that of the controller C11. That is, the controller C14 controls the heater H1 so that the optical power monitor value becomes smaller. In addition, the controller C14 may adjust the oscillation frequency of the wavelength-tunable light source LD4 so that the optical power monitor value becomes larger.

In S5, the controller C21 adjusts the transmission characteristics of the sub-optical circuit F21 based on the optical power monitor value obtained by the optical monitor M21. Here, the sub-optical circuit F21 is assumed to include heaters H1 and H2 as illustrated in FIG. 11. In this case, the controller C21 controls the heaters H1 and H2 so that the optical power monitor value becomes smaller. In addition, the controller C21 may adjust the oscillation frequencies of the tunable light sources LD1, LD3, LD5, and LD7 so that the optical power monitor value becomes larger.

In S6, the controller C22 adjusts the transmission characteristics of the sub-optical circuit F22 based on the optical power monitor value obtained by the optical monitor M22. The operation of the controller C22 is substantially the same as that of the controller C21. That is, the controller C22 controls the heaters H1 and H2 so that the optical power monitor value becomes larger. In addition, the controller C22 may adjust the oscillation frequency of the wavelength-tunable light sources LD2, LD4, and LD6 so that the optical power monitor value becomes smaller.

In S7, the controller C31 adjusts the transmission characteristics of the sub-optical circuit F31 based on the optical power monitor value obtained by the optical monitor M31 and the optical power monitor value obtained by the optical monitor M33. Here, the sub-optical circuit F31 includes the heaters H1 to H5 as illustrated in FIG. 13. In this case, the controller C31 controls the heaters H1 to H5 so that the optical power monitor value obtained by the optical monitor M31 becomes larger. The controller C31 also controls the heaters H1 to H5 so that the optical power monitor value obtained by the optical monitor M33 becomes larger.

In S8, the controller C32 adjusts the transmission characteristics of the sub-optical circuit F32 based on the optical power monitor value obtained by the optical monitor M32 and the optical power monitor value obtained by the optical monitor M34. The operation of the controller C32 is substantially the same as that of the controller C31. That is, the controller C32 controls the heaters H1 to H5 so that the optical power monitor value obtained by the optical monitor M32 increases, and controls the heaters H1 to H5 so that the optical power monitor value obtained by the optical monitor M34 increases.

In S9, the controller C41 adjusts the transmission characteristics of the sub-optical circuit F41 based on the optical power monitor value obtained by the optical monitor M41 and the optical power monitor value obtained by the optical monitor M42. Here, the sub-optical circuit F41 includes the heaters H1 to H5 as illustrated in FIG. 13. In this case, the controller C41 controls the heaters H1 to H5 so that the optical power monitor value obtained by the optical monitor M41 increases. The controller C31 also controls the heaters H1 to H5 so that the optical power monitor value obtained by the optical monitor M42 increases.

In S10, a controller 31b controls the tunable light source based on the optical power monitor value obtained by the optical monitor M31. Specifically, the controller 31b adjusts the oscillation frequencies of the tunable light sources LD1, LD3, LD5, and LD7 so that the optical power monitor value obtained by the optical monitor M31 becomes larger.

In S11, a controller 32b controls the tunable light source based on the optical power monitor value obtained by the optical monitor M32. Specifically, the controller 32b adjusts the oscillation frequencies of the tunable light sources LD2, LD4, and LD6 so that the optical power monitor value obtained by the optical monitor M32 becomes larger.

In S12, a controller 41b controls the tunable light source based on the optical power monitor value obtained by the optical monitor M41. Specifically, the controller 41b adjusts the oscillation frequencies of the tunable light sources LD1 to LD7 so that the optical power monitor value obtained by the optical monitor M41 becomes larger.

The processes S1 to S12 are repeatedly executed until a predetermined convergence condition is satisfied. The convergence condition may be, for example, the quality of each subcarrier. In this case, the processes S1 to S12 are repeatedly executed until the optical signal-to-noise ratio or error rate measured at the receiving node receiving the WDM signal becomes smaller than a predetermined level. Alternatively, the processes S1 to S12 may be executed a predetermined number of times. In this case, the number of times is determined by simulation or the like.

The order in which S1 to S12 are executed is not limited to the embodiment illustrated in FIG. 20, and the optical transmitter 200 can execute S1 to S12 in any order. Furthermore, two or more processes may be executed in parallel. For example, the process of adjusting the characteristics of the sub-optical circuit F and the process of adjusting the oscillation frequency of the wavelength-tunable light source may be executed in parallel or in a time-division manner.

Note that the controllers (C11-14, C21-C22, C31, C31b, C32, C32b, C41, C41b) may be implemented by one processor or by multiple processors. The controllers may also be implemented by hardware circuits.

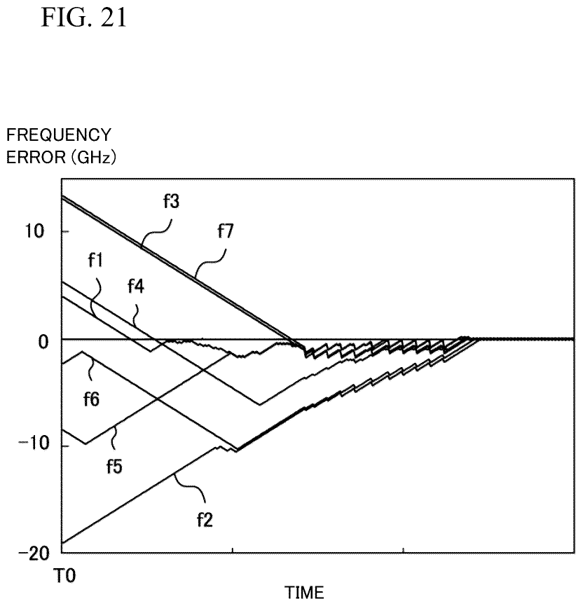

FIG. 21 illustrates the results of a simulation of the process of correcting the frequency of each subcarrier. The horizontal axis of this graph represents time (or the number of repetitions of the process of the flowchart illustrated in FIG. 20). The vertical axis represents the error of each subcarrier with respect to the target frequency. The target frequency is, for example, a WDM frequency grid. Note that the frequency error of the high-precision light source L8 is assumed to be zero. According to this simulation, the frequencies f1-f7 of each subcarrier converge to the target frequency.

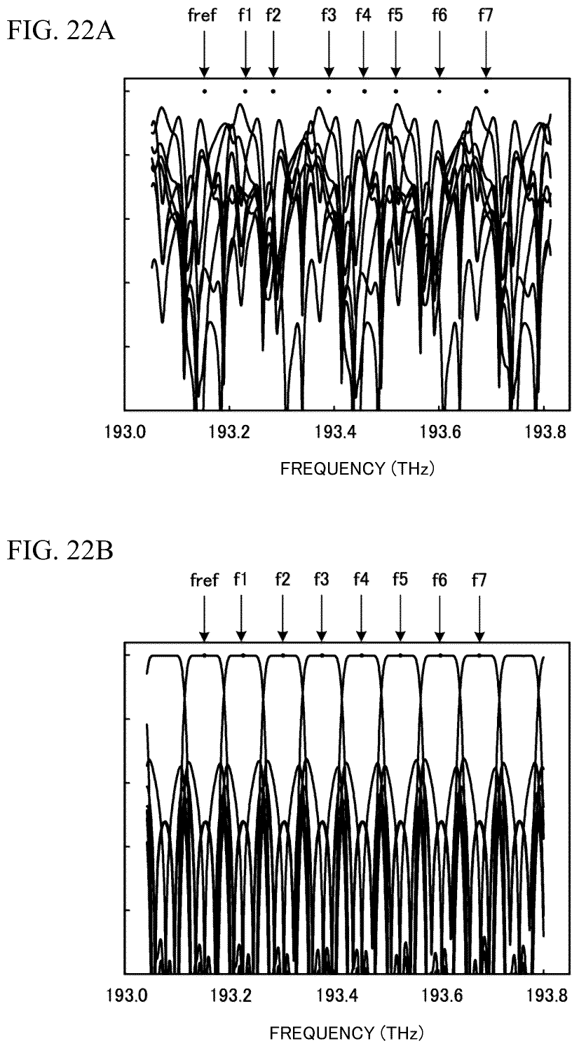

FIG. 22A and FIG. 22B illustrate the results of a simulation of the transmittance of the optical transmitter 200. FIG. 22A illustrates the state before frequency correction according to an embodiment of the present invention is performed. This state corresponds to the spectrum at time TO illustrated in FIG. 21. FIG. 22B illustrates the state after frequency correction according to an embodiment of the present invention has been performed. When frequency correction according to an embodiment of the present invention is performed in this way, the transmission characteristics of each of the subcarriers f1 to f7 and fref are improved, and a WDM signal of good quality is transmitted.

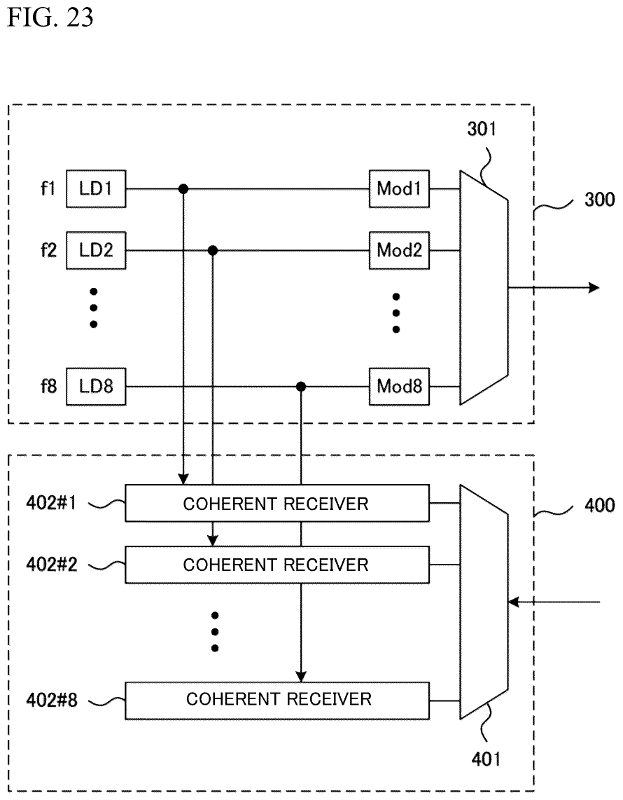

FIG. 23 illustrates an example of an optical transceiver according to an embodiment of the present invention. The optical transceiver according to an embodiment of the present invention comprises an optical transmitter 300 and an optical receiver 400. The optical transmitter 300 corresponds to the optical transmitter 200 illustrated in FIG. 3. Therefore, one of the light sources LD1 to LD8 illustrated in FIG. 23 corresponds to the high-precision light source LD8 illustrated in FIG. 3. Also, an optical circuit 301 illustrated in FIG. 23 corresponds to the sub-optical circuits F11-F14, F21-F22, F31-F32, and F41, the optical monitors M11-M14, M21-M22, M31-M34, and M41-M42, and the controllers C11-14, C21-C22, C31, C31b, C32, C32b, and C41 illustrated in FIG. 3. Therefore, the continuous lights f1-f8 output from the light sources LD1-LD8 are each arranged on a WDM grid.

The optical receiver 400 includes an optical demultiplexer 401 and coherent receivers 402 #1-402 #8. The optical demultiplexer 401 separates the received WDM signal into wavelength channels and guides them to the corresponding coherent receivers 402 #1-402 #8. Each of the coherent receivers 402 #1 to 402 #8 generates an electric field information signal representing the electric field of the modulated optical signal of the corresponding wavelength channel by using the continuous light generated by the corresponding local light source. Here, the local light source is the light sources LD1 to LD8 mounted in the optical transmitter 300. Therefore, the coherent receivers 402 #1 to 402 #8 generate an electric field information signal of the received optical signal by using the light sources LD1 to LD8, respectively. The electric field information signals generated by the coherent receivers 402 #1 to 402 #8 are processed by a DSP (Digital Signal Processor) (not illustrated).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An optical transmitter that multiplexes and outputs a plurality of optical signals, comprising:
a plurality of light sources;
a plurality of optical modulators that generate a plurality of modulated optical signals using output light of the plurality of light sources; and
an optical circuit that multiplexes the plurality of modulated optical signals,
wherein:
one of the plurality of light sources is a reference light source that outputs a reference light;
other light sources of the plurality of light sources are wavelength-tunable light sources;
the optical circuit includes a plurality of sub-optical circuits;
each of the plurality of sub-optical circuits has a first port, a second port, a third port, and a fourth port;
each of the plurality of sub-optical circuits has a periodic transmission characteristic;
transmission characteristic between the first port and the third port and transmission characteristic between the second port and the fourth port are substantially same;
transmission characteristic between the first port and the fourth port and transmission characteristic between the second port and the third port are substantially same;
transmission characteristic between the first port and the third port and transmission characteristic between the first port and the fourth port are complementary;
transmission characteristic between the second port and the third port and transmission characteristic between the second port and the fourth port are complementary;
each of the plurality of sub-optical circuits includes a phase shifter for adjusting transmission characteristic;
each of the plurality of sub-optical circuits is configured to multiplex an input light of the first port and an input light of the second port by the phase shifter and output a multiplexed light through the third port;
the plurality of sub-optical circuits are optically coupled to each other to configure a binary tree circuit including N stages;
the third port of a set of sub-optical circuits provided in an (i+1)-th stage of the binary tree circuit is optically coupled to the first port and the second port of a sub-optical circuit provided in an i-th stage of the binary tree circuit with respect to an output port of the optical transmitter;
corresponding modulated optical signals among the plurality of modulated optical signals are guided from the plurality of optical modulators to the first port and the second port of each sub-optical circuit provided in an N-th stage of the binary tree circuit; and
a reference optical signal generated by one of the plurality of optical modulators using the reference light is guided to the fourth port of an output stage sub-optical circuit connected to the output port of the optical transmitter.

2. The optical transmitter as claimed in claim 1 further comprising:
a first controller that controls an oscillation frequency of a wavelength-tunable light source corresponding to the modulated optical signal input to a first sub-optical circuit based on an output power of the third port or the fourth port of the first sub-optical circuit among the plurality of sub-optical circuits.

3. The optical transmitter as claimed in claim 2,
wherein the first controller controls the oscillation frequency of the wavelength-tunable light source corresponding to the modulated optical signal input to the first sub-optical circuit so that output power of the third port is increased or output power of the fourth port is decreased.

4. The optical transmitter as claimed in claim 1 further comprising:
a second controller configured to control the phase shifter included in a second sub-optical circuit among the plurality of sub-optical circuits based on output power of the third port or the fourth port of the second sub-optical circuit.

5. The optical transmitter as claimed in claim 4,
wherein the second controller controls the phase shifter included in the second sub-optical circuit so that the output power of the third port is increased or the output power of the fourth port is decreased.

6. The optical transmitter as claimed in claim 1 further comprising:
a third controller that controls the phase shifter included in the output stage sub-optical circuit based on the output power of the first port or the second port of the output stage sub-optical circuit.

7. The optical transmitter as claimed in claim 1,
wherein a period of transmission characteristic of the sub-optical circuit provided in the (i+1)-th stage of the binary tree circuit is twice a period of transmission characteristic of the sub-optical circuit provided in the i-th stage of the binary tree circuit.
